(19) United States
(12) Patent Application Publication
(10) Pub. No.: US 2026/0261396 A1
(43) Pub. Date: Sep. 3, 2026

(54) RECEIVING CIRCUIT, SEMICONDUCTOR INTEGRATED CIRCUIT, AND COMMUNICATION SYSTEM

(71) Applicant: Socionext Inc., Kanagawa (JP)

(72) Inventors: Taro MORIAI, Yokohama (JP); Hirohito HIGASHI, Yokohama (JP)

(21) Appl. No.: 19/656,223

(22) Filed: Apr. 23, 2026

Related U.S. Application Data
(63) Continuation of application No. PCT/JP2023/039722, filed on Nov. 2, 2023.

(51) Int. Cl. H04L 7/00; H04L 25/40

(52) U.S. Cl. CPC H04L 7/0012; H04L 7/0041; H04L 25/40

(57) ABSTRACT

A receiving circuit includes: a clock generating circuit configured to generate a reception clock signal; and a plurality of data receiving circuits configured to receive respective data signals based on the reception clock signal. The clock generating circuit includes: a clock receiving circuit configured to receive a reference clock signal; a variable delay circuit configured to generate a delayed reference clock signal by delaying the reference clock signal received by the clock receiving circuit by a delay amount responsive to a delay control signal; a delay synchronization circuit configured to generate a plurality of internal clock signals by delaying the delayed reference clock signal successively; and a selector circuit configured to select one of the plurality of internal clock signals based on a phase selection signal and output the selected internal clock signal as the reception clock signal.

### CROSS-REFERENCE TO RELATED APPLICATIONS

This application is a continuation application of International Application No. PCT/JP2023/039722, filed on November 2, 2023, designating the U.S., the entire contents of which are incorporated herein by reference.

### BACKGROUND

### 1. Field of the Invention

The present invention relates to a receiving circuit, a semiconductor integrated circuit, and a communication system.

### 2. Description of the Related Art

There is a phase adjustment circuit that: supplies an input signal to a phase shift circuit and a variable delay circuit that are connected in series; detects the phases of the delayed input signal and the phase of a reference signal in a delay detection circuit; and ends the detection result to the phase shift circuit and the variable delay circuit as feedback so that both phases are adjusted based on the feedback.

### CITATION LIST

### PATENT DOCUMENTS

Patent Document 1: Unexamined Japanese Patent Application Publication No. HEI09-009285

Patent Document 2: Unexamined Japanese Patent Application Publication No. 2000-224030

Patent Document 3: U.S. Patent Application Publication No. 2004/0130366

Patent Document 4: U.S. Patent Application Publication No. 2008/0252346

### SUMMARY OF THE INVENTION

According to an example of the present invention, a receiving circuit is provided. This receiving circuit includes: a clock generating circuit configured to generate a reception clock signal; and a plurality of data receiving circuits configured to receive respective data signals based on the reception clock signal. The clock generating circuit includes: a clock receiving circuit configured to receive a reference clock signal; a variable delay circuit configured to generate a delayed reference clock signal by delaying the reference clock signal received by the clock receiving circuit by a delay amount responsive to a delay control signal; a delay synchronization circuit configured to generate a plurality of internal clock signals by delaying the delayed reference clock signal successively; and a selector circuit configured to select one of the plurality of internal clock signals based on a phase selection signal and output the selected internal clock signal as the reception clock signal.

### BRIEF DESCRIPTION OF THE DRAWINGS

FIG. 1 is a block diagram for explaining a problem with a receiving circuit that is provided in a system where data signals are communicated and that receives multiple data signals with clock signals;

FIG. 2 is a block diagram showing an example of a system where data signals are communicated according to one embodiment of the present disclosure;

FIG. 3 is a block diagram showing examples of the clock receiver, the variable delay circuit, and the DLL circuit of FIG. 2;

FIG. 4 is a circuit diagram showing an example of the variable delay circuit of FIG. 2;

FIG. 5 is a timing chart showing examples of clock signals generated by the DLL circuit of FIG. 3;

FIG. 6 is a diagram for explaining an example operation in which the variable delay circuit of FIG. 4 makes minor phase adjustments to clock signals;

FIG. 7 is a flowchart showing an example of a calibration operation of the receiving circuit of FIG. 2;

FIG. 8 is a flowchart showing a continuation of the operation of FIG. 7;

FIG. 9 is a flowchart showing an example of the operation of step S200 of FIG. 8;

FIG. 10 is a flowchart showing a continuation of the operation of FIG. 9;

FIG. 11 is a flowchart showing a continuation of the operation of FIG. 10; and

FIG. 12 is a flowchart showing a continuation of the operation of FIG. 11.

### DETAILED DESCRIPTION OF THE PREFERRED EMBODIMENTS

In one existing synchronization circuit, for example, a clock signal is supplied to two phase shift circuits. Each phase shift circuit is comprised of a minor shift circuit that makes minor phase adjustments and a major shift circuit that makes major phase adjustments, which are connected in series. A control circuit selects one of the two phase shift circuits and adjusts the phase of the clock signal. The control circuit starts the minor shift circuit of the selected phase shift circuit to adjust the phase of the clock signal. The control circuit also starts the minor shift circuit and the major shift circuit of the other, unselected phase shift circuit, and, if the delay by the minor shift circuit reaches a threshold, re-selects the phase shift circuit.

There is also a delay-locked loop (DLL) circuit having a phase interpolator and a variable delay circuit that are connected in series. When an input clock signal is supplied to the phase interpolator, an output clock signal having the same phase as the input clock signal is output from the variable delay circuit. This type of DLL circuit generates output clock signals without starting the phase interpolator until the DLL is locked. After the DLL is locked, the phase interpolator is started and generates output clock signals with reduced jitter.

A receiving circuit having multiple data receiving circuits that receive multiple data signals transmitted with clock signals via respective transmission channels can receive proper data signals by correcting the phase difference between data signals and clock signals that is produced over the transmission channels or due to other factors. For example, the data receiving circuits may be each provided with a phase shift circuit for correcting the corresponding clock signal’s phase to an adequate phase.

However, in the event every one of multiple receiving circuits has to be provided with a phase shift circuit, it then follows that more phase shift circuits are present and more data signals are received, resulting in increased overall power consumption of the receiving circuit. Furthermore, although it is possible to provide a common phase shift circuit in multiple data receiving circuits and adjust, for example, the phase of clock signals in accordance with one of multiple data signals, which data signal is preferable for use for adjusting the phase of clock signals has not been discussed.

The present invention has been made in view of the foregoing and aims to generate clock signals that allow multiple data signals to be received at adequate timing, while preventing or substantially preventing an increase in power consumption.

The technique disclosed herein makes it possible to generate clock signals that allow multiple data signals to be received at adequate timing while preventing or substantially preventing an increase in power consumption.

An embodiment of the present disclosure will be described below with reference to the accompanying drawings. In the following description, for example, a symbol that designates a particular signal may also designate a signal line, a signal terminal, or a signal node where the signal is communicated. Likewise, a symbol that designates a certain voltage may also designate a voltage line, a voltage terminal, or a voltage node where the voltage is supplied. In the event complementary signal lines are used, a signal line illustrated as a single line may be complementary signal lines.

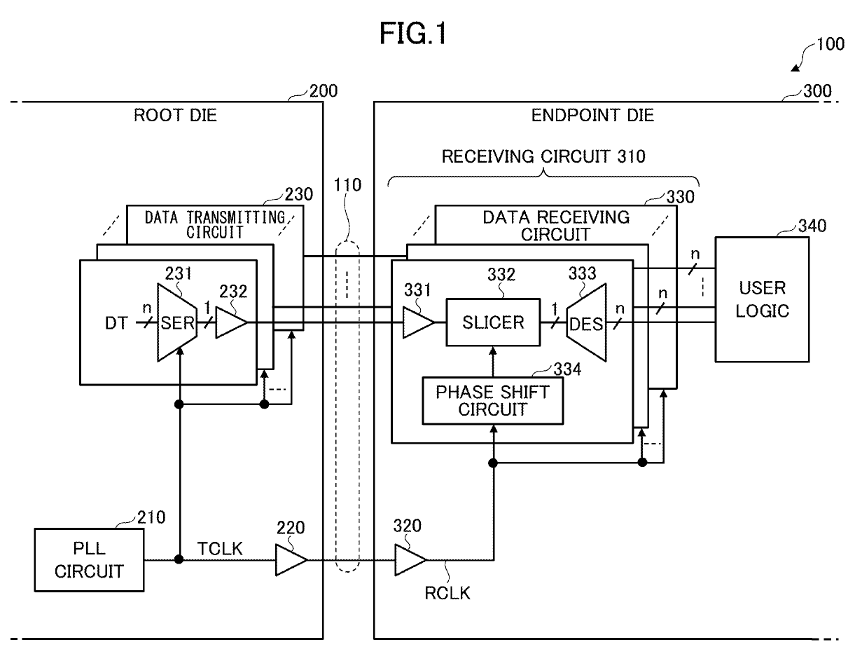

FIG. 1 is a block diagram for explaining a problem with a receiving circuit that is provided in a system where data signals are communicated and that receives multiple data signals with clock signals. In FIG. 1, a system 100 includes a root die 200 and an endpoint die 300, which are connected with each other via a transmission channel 110.

The root die 200 includes a phase-locked loop (PLL) circuit 210, a clock driver 220, and multiple data transmitting circuits 230. Each data transmitting circuit 230 includes a serializer (SER) 231 and a data driver 232. The endpoint die 300 includes a receiving circuit 310 and a user logic 340. The receiving circuit 310 includes a clock receiver 320 and multiple data receiving circuits 330. Each data receiving circuit 330 includes a data receiver 331, a slicer 332, a deserializer (DES) 333, and a phase shift circuit 334.

In the root die 200, the PLL circuit 210 generates, based on an input clock signal (not shown), a transmission clock signal TCLK that is in phase with the input clock signal. The clock driver 220 transmits the transmission clock signal TCLK to the clock receiver 320 of the endpoint die 300 via the transmission channel 110. In each data transmitting circuit 230, the serializer 231 converts n-bit parallel data signals DT into a serial data signal in sync with the transmission clock signal TCLK, and outputs the serial data signal to the data driver 232. The data driver 232 transmits the data signal arriving from the serializer 231 to a corresponding data receiving circuit 330 of the endpoint die 300 via the transmission channel 110.

In the endpoint die 300, the clock receiver 320 receives the transmission clock signal TCLK from the root die 200 via the transmission channel 110, and outputs this signal to the phase shift circuit 334 of each data receiving circuit 330 as a reception clock signal RCLK. In each data receiving circuit 330, the phase shift circuit 334, including an analog circuit such as an operational amplifier, shifts the phase of the reception clock signal RCLK based on the amount of shift set therein, and outputs the resulting signal to the slicer 332.

For example, before data signals to be processed in the user logic 340 arrive from the root die 200, the endpoint die 300 performs calibration so that the amount of phase shift to apply to each reception clock signal RCLK is determined per data receiving circuit 330. For example, the endpoint die 300 determines the amount of shift for each data receiving circuit 330 such that the phase of the reception clock signal RCLK coincides with the center of or between both transient edges of a test data signal transmitted from the corresponding data transmitting circuit 230.

The data receiver 331 receives the serial data signal transmitted from the corresponding data transmitting circuit 230 in the root die 200, and outputs the received data signal to the slicer 332. The slicer 332 acquires the data signal in sync with the reception clock signal RCLK that arrives from the phase shift circuit 334 with a shifted phase, and outputs the acquired data signal to the deserializer 333. The deserializer 333 converts the serial data signal arriving from the slicer 332 into parallel n-bit data signals and outputs them to the user logic 340. The deserializer 333 is an example of a serial-to-parallel conversion circuit that converts multiple serial data signals, received successively via the transmission channel 110, into parallel data signals.

The user logic 340 processes the n-bit data signals arriving from multiple data receiving circuits 330. For example, the user logic 340 may include a processor, a memory, or a logic circuit.

The endpoint die 300 shown in FIG. 1 has a phase shift circuit 334, which includes an analog circuit such as an operational amplifier, for each data receiving circuit 330, and therefore consumes more power than when a phase shift circuit 334 is not provided for every data receiving circuit 330. Furthermore, the greater the number of lanes that make up the transmission channel 110 where data signals are transmitted, the greater the number of phase shift circuits 334 installed in the endpoint die 300, resulting in greater power consumption by the endpoint die 300.

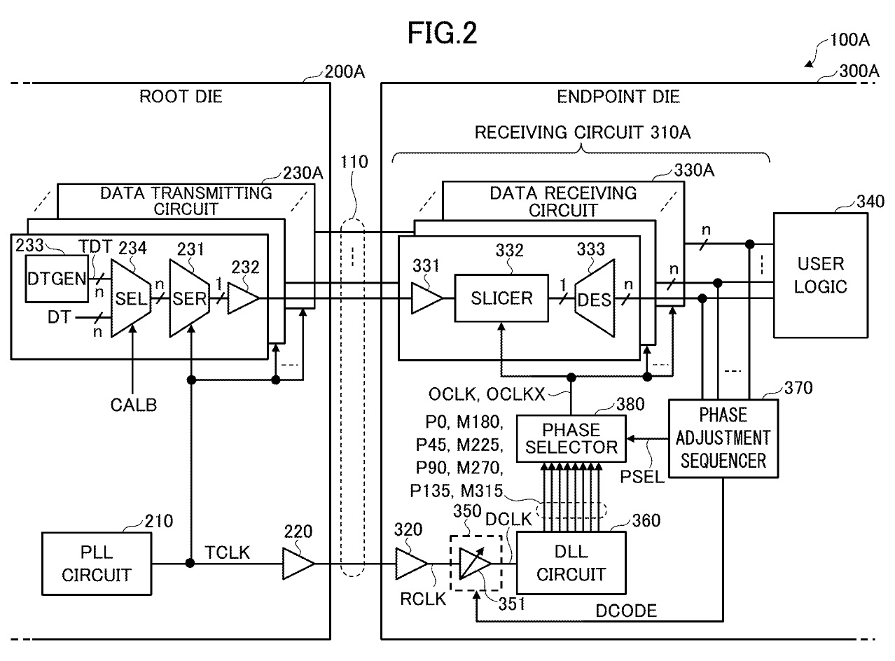

FIG. 2 shows an example of a system for communicating data signals according to one embodiment of the present disclosure. In FIG. 2, a system 100A includes a root die 200A and an endpoint die 300A, which are connected with each other via a transmission channel 110 made up of multiple lanes.

The root die 200A and the endpoint die 300A may be semiconductor integrated circuits such as SoCs (systems on chips) or FPGAs (field-programmable gate arrays). For example, the system 100A may comply with “bunch of wires” (BoW), “die-to-die” (D2D), or other interconnect standards.

The root die 200A includes a PLL circuit 210, a clock driver 220, and multiple data transmitting circuits 230A. Each data transmitting circuit 230A includes a data generating circuit (DTGEN) 233, a selection circuit (SEL) 234, a serializer (SER) 231, and a data driver 232.

The endpoint die 300A includes a receiving circuit 310A and a user logic 340. The receiving circuit 310A includes a clock receiver 320, a variable delay circuit 350, a DLL circuit 360, a phase adjustment sequencer 370, a phase selector 380, and multiple data receiving circuits 330A. Each data receiving circuit 330A includes a data receiver 331, a slicer 332, and a deserializer (DES) 333. The user logic 340 is an example of a processing circuit for processing multiple data signals received in the receiving circuits 310A. The user logic 340 may be provided outside the endpoint die 300A.

The clock receiver 320, variable delay circuit 350, DLL circuit 360, and phase selector 380 work together as an example of a clock generating circuit that generates output clock signals OCLK and OCLKX. The clock receiver 320 is an example of a clock receiving circuit that receives a transmission clock signal TCLK. The DLL circuit 360 is an example of a delay synchronization circuit. The phase selector 380 is an example of a selector circuit.

In the root die 200A, the clock driver 220 of each data transmitting circuit 230 transmits a transmission clock signal TCLK to the clock receiver 320 of the endpoint die 300A via the transmission channel 110. In the root die 200A, a calibration signal CALB, which indicates that calibration mode is in effect, is generated based on a command from the endpoint die 300A. When the calibration signal CALB indicates that calibration mode is in effect, the data generating circuit 233 generates a test data signal TDT and outputs it to the selection circuit 234. The calibration signal CALB is generated during calibration mode. When calibration mode is in effect, the calibration signal CALB is generated so that, for example, the endpoint die 300A can look for a clock signal’s phase corresponding to adequate timing and receive the corresponding data signal properly.

Individual calibration signals CALB may be supplied to multiple data transmitting circuit 230A successively. In this case, for example, one data transmitting circuit 230A may generate a test data signal TDT and transmits it to the endpoint die 300A. Alternatively, a common calibration signal CALB may be supplied to multiple data transmitting circuits 230A. In this case, all data transmitting circuits 230A generate test data signals TDT at the same time and transmit them to the endpoint die 300A.

When no calibration signal CALB is present to indicate that calibration mode is in effect, that is, when the system is operating, for example, each selection circuit 234 selects and outputs n-bit data signals DT to the serializer 231. When a calibration signal CALB is present to indicate that calibration mode is in effect, that is, when calibration mode is in effect, for example, each selection circuit 234 selects and outputs n-bit test data signals TDT to the serializer 231.

Each serializer 231 converts the n-bit data signals DT or test data signals TDT into a serial data signal in sync with the transmission clock signal TCLK, and transmits the converted serial data signal to a corresponding data receiving circuit 330A via the data driver 232. For example, in the event multiple data transmitting circuits 230A are present, the data transmitting circuits 230A may convert respective data signals DT, which are mutually-independent, separate data signals, into respective serial data signals, through respective serializers 231, and send the resulting serial data signals onto the transmission channel 110. In other words, mutually independent, separate data signals DT are transmitted to multiple lanes that make up the transmission channel 110 and that are connected to respective data transmitting circuits 230A.

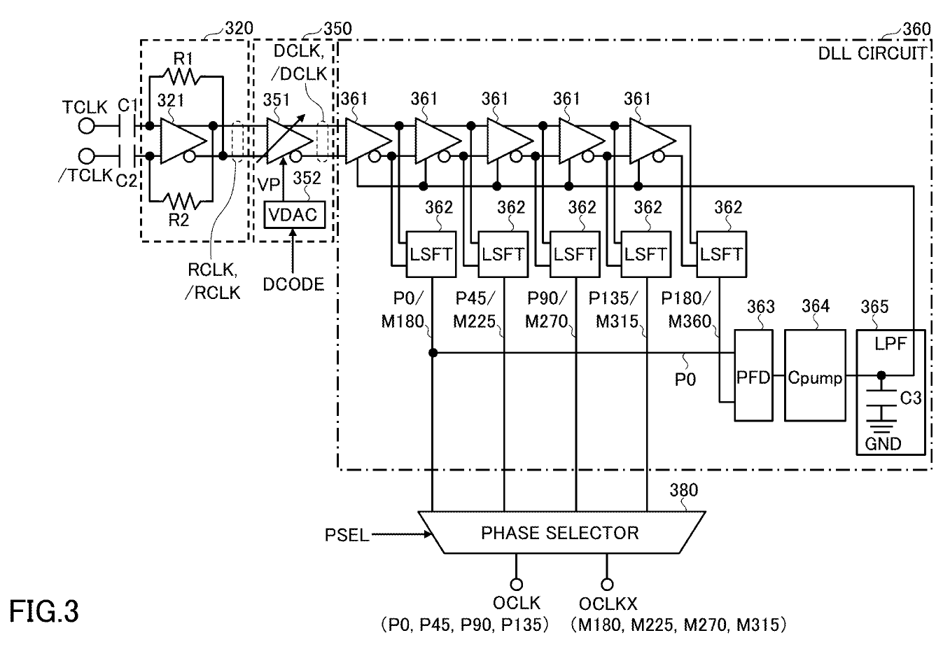

In the endpoint die 300A, when receiving a transmission clock signal TCLK from the root die 200A via the transmission channel 110, the clock receiver 320 outputs it to the variable delay circuit 350 as a reception clock signal RCLK. The variable delay circuit 350 adjusts (delays) the phase of the reception clock signal RCLK according to a delay code DCODE and outputs the resulting clock signal to a DLL circuit 360 as a clock signal DCLK. The DLL circuit 360 generates clock signals P0, P45, P90, P135, M180, M225, M270, and M315, with phase differences of 0 degrees, 45 degrees, 90 degrees, 135 degrees, 180 degrees, 225 degrees, 270 degrees, and 315 degrees, respectively, with respect to the clock signal DCLK from the variable delay circuit 350, and outputs these clock signals P0 to M315 to the phase selector 380. The clock signals P0, P45, P90, P135, M180, M225, M270, and M315 are examples of internal clock signals. FIG. 3 shows an example of the DLL circuit 360.

The phase adjustment sequencer 370 operates while calibration mode is in effect and monitors the test data signals TDT output from the data receiving circuits 330A. Calibration mode is an example of test mode. The phase adjustment sequencer 370 generates a phase selection signal PSEL and a delay code DCODE for use for generating output clock signals OCLK and OCLKX that are suitable for all data receiving circuits 330A, and outputs the phase selection signal PSEL and the delay code DCODE to the phase selector 380 and the variable delay circuit 350, respectively. The phase adjustment sequencer 370 is an example of a phase adjustment control circuit.

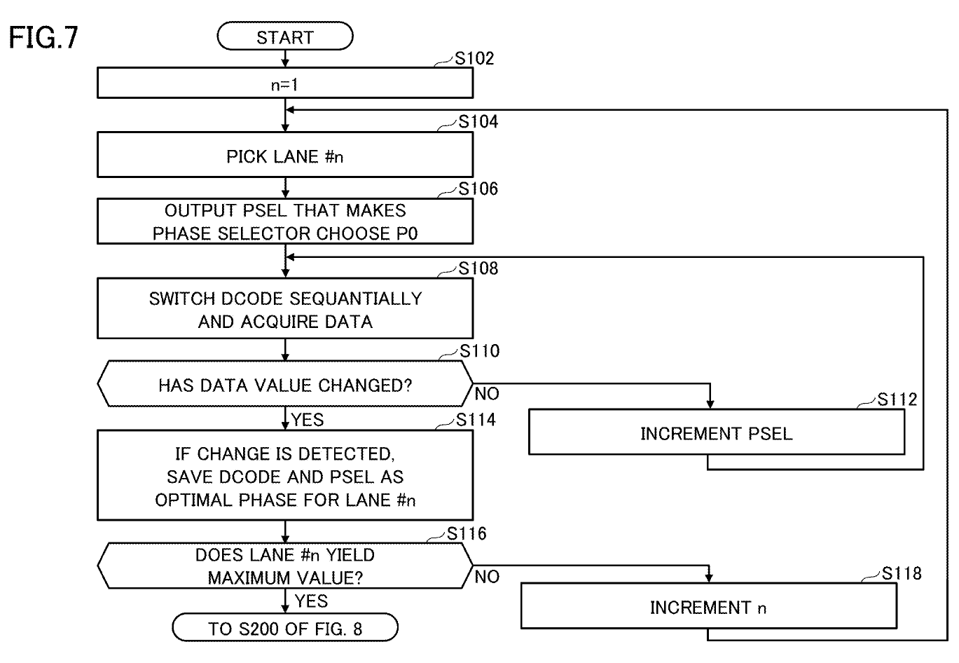

By this means, after calibration mode switches to system operation mode and the data signals DT start arriving, each data receiving circuit 330A can receive the data signals at adequate timing. FIG. 7 to FIG. 12 show examples of operations for selecting output clock signals OCLK and OCLKX with appropriate phases by using the phase adjustment sequencer 370. The output clock signals OCLK and OCLKX are examples of common reception clock signals that all data receiving circuits 330A receive.

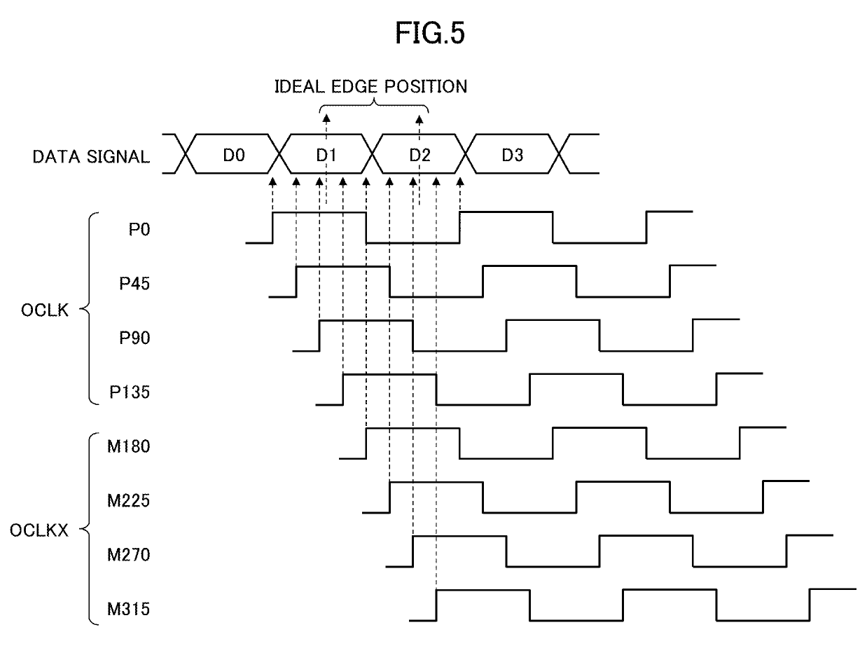

The phase selector 380 selects one of the clock signals P0, P45, P90, and P135, depending on the phase selection signal PSEL output from the phase adjustment sequencer 370, and outputs it as an output clock signal OCLK. Likewise, the phase selector 380 selects one of the clock signals M180, M225, M270, and M315, depending on the phase selection signal PSEL, and outputs it as an output clock signal OCLKX. FIG. 5 shows the waveforms of the clock signals P0, P45, P90, P135, M180, M225, M270, and M315.

Referring to FIG. 2, each data receiving circuit 330A is structured the same or substantially the same as the data receiving circuits 330 of FIG. 1 excepting the phase shifter 334. Each data receiver 331 receives a data signal transmitted from the corresponding data transmitting circuit 230A in the root die 200A, and outputs the received data signal to the slicer 332. For example, in the event multiple data receiving circuits 330A are present, the respective data receivers 331 output, to the slicers 332, data signals that are separate and mutually independent from one another, via multiple lanes that make up the transmission channel 110. Each slicer 332 acquires the data signals arriving from the data receiver 331 in sync with the output clock signal OCLK or OCLKX and outputs the acquired data signals to the deserializer 333.

Each deserializer 333 converts the serial data signals from the slicer 332 into parallel n-bit data signals and outputs them to the user logic 340. For example, in the event multiple data receiving circuits 330A are present, mutually independent, separate data signals arrive from the respective data transmitting circuits 230A connected via the transmission channel 110, and are converted into parallel data signals.

FIG. 3 shows examples of the clock receiver 320, variable delay circuit 350, and DLL circuit 360 of FIG. 2. The clock receiver 320 includes a buffer 321 and resistors R1 and R2. The variable delay circuit 350 includes a delay buffer 351 and a voltage digital-to-analog conversion circuit (VDAC) 352. The DLL circuit 360 includes five buffers 361 that are connected in series, five level shifters (LSFT) 362, a phase frequency comparator (PFD) 363, a charge pump (Cpump) 364, and a low-pass filter (LPF) 365.

Each buffer 361 is an example of a delay buffer. Multiple buffers 361 are connected in series, providing an example of a delay buffer sequence. The phase frequency comparator 363, charge pump 364, and low-pass filter 365 constitute an example of a delay adjustment circuit, which adjusts the delay in the buffers 361 based on the phase difference between the clock signals P0 and M360 such that their phase difference becomes equal to one period of the clock signal DCLK.

The buffer 321 of the clock receiver 320 is, for example, a current mode logic (CML) buffer. The buffer 321 receives differential transmission clock signals of opposite signs, TCLK and /TCLK, via capacitors C1 and C2, and outputs differential reception clock signals, RCLK and /RCLK, to the variable delay circuit 350. In this specification, a signal prefixed by a slash is of the opposite sign to the preceding or counterpart signal (e.g., TCLK and /TCLK). The reception clock signal pair RCLK and /RCLK are examples of reference clock signals. The clock receiver 320 determines a differential common voltage by connecting the differential inputs to outputs of opposite signs via the resistors R1 and R2.

The VDAC 352 of the variable delay circuit 350 generates a voltage VP according to the logic of the delay code DCODE that arrives from the phase adjustment sequencer 370 of FIG. 2. The delay buffer 351 delays the differential reception clock signal pair RCLK and /RCLK received from the clock receiver 320 according to the voltage VP given from the VDAC 352, and outputs the delayed signals as differential clock signals DCLK and /DLCK to the first stage of buffers 361 of the DLL circuit 360.

The buffers 361 in the DLL circuit 360 are, for example, CML buffers. Each buffer 361 delays the differential clock signals according to a voltage generated by the low-pass filter 365, and outputs the delayed clock signals to the following buffer 361 and level shifter 362. The buffers 361 and the level shifters 362 are provided on a one-to-one basis. Each level shifter 362 converts the voltage levels of the differential clock signals output from the corresponding buffer 361 to CMOS levels.

The level shifters 362 output the differential clock signals with converted voltage levels as clock signals “P0/M180,” “P45/M225,” “P90/M270,” “P135/M315,” and “P180/M360.” The clock signals P0/M180, P45/M225, P90/M270, and P135/M315 are output to the phase selector 380. The clock signals P180/M360 are output to the phase frequency comparator 363.

The phase frequency comparator 363 generates a control signal (e.g., a pulse signal) for controlling the charge pump 364 based on the phase difference between the clock signal P01 and the clock signal M360. The charge pump Cpump outputs a current in accordance with the control signal from the phase frequency comparator 363, to the low-pass filter 365. The low-pass filter 365 generates a voltage in accordance with the current from the charge pump Cpump, and outputs the generated voltage to a control terminal of each buffer 361.

The DLL circuit 360 adjusts the delay in each buffer 361 by controlling the phase frequency comparator 363, charge pump Cpump, and low-pass filter 365 to make the phase difference between the clock signals P0 and M360 zero. By this means, the clock signals P0, P45, P90, P135, M180, M225, M270, and M315, each lagging 45 degrees in phase behind the preceding signal, are generated.

The phase selector 380 selects one pair of clock signals from P0/M180, P45/M225, P90/M270, and P135/M315 based on, for example, the logical values of the 2-bit phase selection signal PSEL. The phase selector 380 outputs the selected pair as output clock signals OCLK and OCLKX.

Although FIG. 3 shows an example in which differential clock signals are used, single-phase clock signals may be used as well. Also, in FIG. 2, differential data signals or single-phase data signals may be transmitted from the data transmitting circuit 230A to the data receiving circuit 330A.

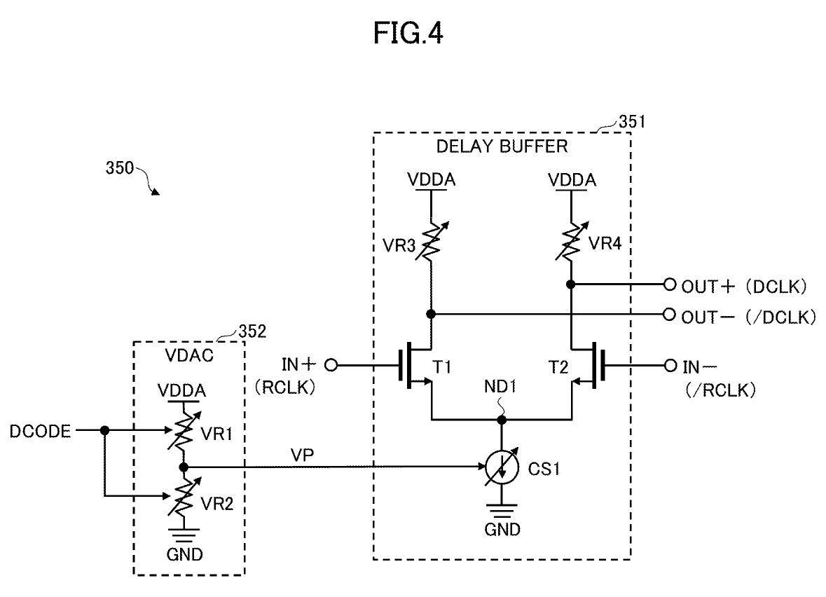

FIG. 4 shows an example of the variable delay circuit 350 of FIG. 2. The VDAC 352 has variable resistors VR1 and VR2, which are connected in series, via a node VP, between a power supply line VDDA and a ground line GND. The resistance values of the variable resistors VR1 and VR2 change depending on the value of the delay code DCODE. The VDAC 352 then outputs a voltage VP in accordance with the value of the delay code DCODE. For example, the larger the value of the delay code DCODE, the lower the value of the voltage VP, or the smaller the value of the delay code DCODE, the higher the value of the voltage VP. If the delay code DCODE is n bits, the VDAC 352 can output 2ⁿ different voltages VP. The VDAC 352 is an example of a voltage generating circuit that generates voltage in accordance with the value of the delay code DCODE.

The delay buffer 351 includes variable resistors VR3 and VR4, transistors T1 and T2, and a current source CS1. For example, the variable resistors VR3 and VR4 are set to predetermined resistance values in advance. For example, the transistors T1 and T2 are n-channel metal oxide semiconductor (MOS) transistors. The gate of the transistor T1 is connected to an input terminal IN+, where the reception clock signal RCLK is received. The gate of the transistor T2 is connected to an input terminal IN-, where the reception clock signal /RCLK is received.

The variable resistor VR3 and the transistor T1 are connected in series between the power supply line VDDA and the node ND1 via an output terminal out-, from which the clock signal /DCLK is output. The variable resistor VR4 and the transistor T2 are connected in series between the power supply line VDDA and the node ND1 via an output terminal out+, from which the clock signal DCLK is output. The current source CS1 is connected between the node ND1 and the ground line GND, and a current matching the voltage VP flows therefrom. For example, the current source CS1 lowers the current level when the voltage VP is relatively lower, and increases the current level when the voltage VP is relatively higher.

For example, the lower the voltage VP, the greater the difference in delay between: the differential reception clock signal pair RCLK and /RCLK received at differential input terminals IN+ and IN-; and the differential clock signal pair DCLK and /DCLK output from the differential output terminals OUT+ and OUT-. Furthermore, the higher the voltage VP, the shorter the difference in delay between: the reception clock signal pair RCLK and /RCLK; and the clock signal pair DCLK and /DCLK. In other words, the delay buffer 351 increases the delay when value of the delay code DCODE increases and lowers the delay when the value of the delay code DCODE decreases. If the delay code DCODE is n bits, the delay buffer 351 can set 2ⁿ patterns of delays.

FIG. 5 shows examples of clock signals generated by the DLL circuit 360 of FIG. 3. As described earlier, the DLL circuit 360 generates the clock signals P0, P45, P90, P135, M180, M225, M270, M315, and M360, each lagging 45 degrees in phase behind the preceding signal. When the slicer 332 of FIG. 2 receives data signals, it is preferable if each data signal is acquired at the center of the period for receiving that data signal (at the timing of the center between the transient edges on both sides, or at the “ideal edge position”).

In the event the phases of the data signal received by the slicer 332 and the clock signals P0, P45, P90, P135, M180, M225, M270, and M315 hold the relationship shown in FIG. 5, the clock signal being the closest to the ideal edge position for the data signal D1 is the clock signal P90. Furthermore, the clock signal being the closest to the ideal edge position for the data signal D2 is the clock signal M270 with a phase lagging behind the clock signal P90 by 180 degrees.

Nevertheless, the DLL circuit 360 can only select one of four clock signals of varying phases per data signal, and it is difficult to generate clock signals meeting ideal edge positions using the DLL circuit 360 alone. Therefore, the variable delay circuit 350 makes minor adjustments to the phases of clock signals. As shown in FIG. 5, the receiving circuit 310A (FIG. 2) has a half-rate architecture, in which the clock rate is 1/2 of the data rate.

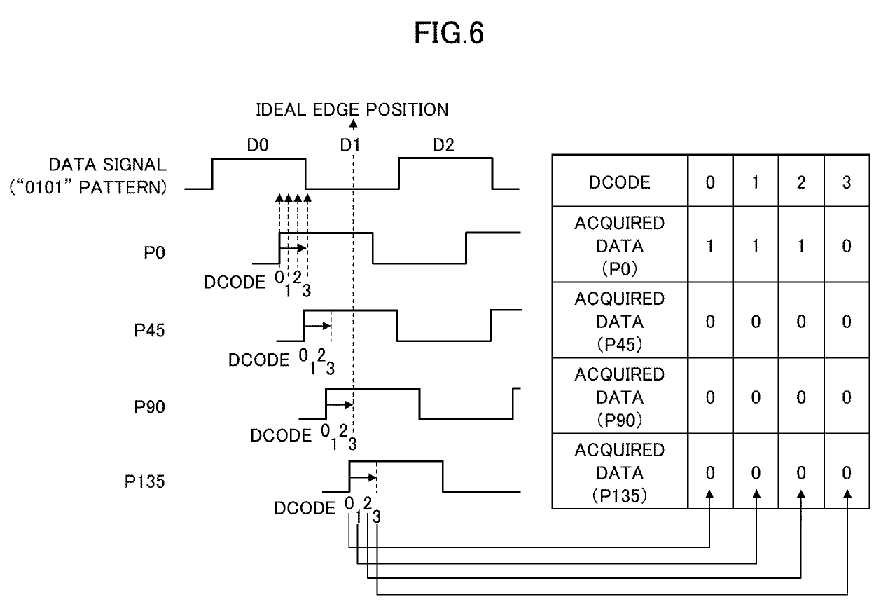

FIG. 6 shows an example of an operation in which the variable delay circuit 350 of FIG. 4 makes minor adjustments to the phases of clock signals. In the example shown in FIG. 6, the data signal has a “0101” pattern, in which the logical values “0” and “1” appear alternately (hereinafter also simply referred to as “logical 1” and “logical 0”).

In calibration mode, the phase adjustment sequencer 370 of FIG. 2 switches the clock signal to be selected by the phase selector 380 from P0 to P45, P90, and P135, in this order. Furthermore, the phase adjustment sequencer 370 switches the delay in the variable delay circuit 350 successively according to changes of the delay code DCODE. Then, the phase adjustment sequencer 370 obtains the data signal’s logical values per combination of the clock signal P0, P45, P90, or P135 and a delay code DCODE, and searches for a delay code DCODE in which the logical value switches.

For example, looking at the clock signal P0 in FIG. 6, a logical “1” is obtained from the delay code DCODE “0” to “2,” and logical “0” is obtained when the delay code DCODE is “3” or greater. In other words, the logical value switches when the delay code DCODE changes from “2” to “3.” For the clock signals P45, P90, and P135, a logical “0” is obtained from all delay codes DCODE.

The phase adjustment sequencer 370 then outputs, to the phase selector 380, a phase selection signal PSEL that makes the phase selector 380 select the clock signal P90, which lags 90 degrees in phase behind the clock signal P0 in which the logical value switches. The phase adjustment sequencer 370 then outputs the delay code DCODE “2” or “3” where the logical value switches, to the variable delay circuit 350. As a result of this, when the system is operating in calibration mode, the slicer 332 in each data receiving circuit 330A can, for example, acquire a data signal in sync with: a clock signal OCLK having a transient edge near the center of the data signal; and a clock signal OCLKX lagging 180 degrees in phase behind the clock signal OCLK.

FIG. 7 to FIG. 12 show examples of calibration operations that take place in the receiving circuit 310A of FIG. 2. Referring back to FIG. 2, during the calibration operation, the system 100A enters calibration mode and the clock signals’ phases are determined such that all data receiving circuits 330A can receive data signals properly. During calibration mode, the endpoint die 300A commands the root die 200A to generate test data TDT.

For example, when a command is issued from the endpoint die 300A, the root die 200A controls the data generating circuit (DTGEN) 233 in each data transmitting circuit 230A to generate test data TDT, and, outputting a calibration signal CALB to the selection circuit 234, makes the selection circuit 234 select the test data TDT.

The operations shown in FIG. 7 to FIG. 12 may be carried out using hardware that implements the phase adjustment sequencer 370. If the phase adjustment sequencer 370 is implemented using a processor such as a CPU installed in the endpoint die 300A, the operations shown in FIG. 7 to FIG. 12 may be carried out, for example, by a program executed by the processor. Alternatively, the operations shown in FIG. 7 to FIG. 12 may be implemented by a combination of hardware and software that implement the phase adjustment sequencer 370 together.

Components that are used during calibration mode will be described below. The system 100A has n existing lanes (an even number of lanes) where serial data signals are transmitted from the root die 200A to the endpoint die 300A. The number of lanes, “n,” is equal to the number of data transmitting circuits 230A and the number of data receiving circuits 330A. “Lane #n” used herein indicates the index number of the lane that is selected at present and is also used to refer to the lane itself.

The phase selection signal PSEL is 2 bits. The phase selector 380 can select four pairs of clock signals, namely P0/M180, P45/M225, P90/M270, and P135/M31, depending on the phase selection signal PSEL. In the following description, the values of the two bits that make up the phase selection signal PSEL will be referred to as “PSEL<2:1>.” The part “PSEL<2>” is the value of the high-order bit of the phase selection signal PSEL. The part “PSEL<1>” is the value of the low-order bit of the phase selection signal PSEL. In this specification, “high-order bit” and “low-order bit” may be interchangeable with “most significant bit (MSB)” and “least significant bit (LSB),” respectively.

The phase selector 380 selects the clock signals P0/M180 when PSEL<2:1> is “00,” and selects the clock signals P45/M225 when PSEL<2:1> is “01.” The phase selector 380 selects the clock signals P90/M270 when PSEL<2:1> is “10” and selects the clock signals P135/M315 when PSEL<2:1> is “11.”

In calibration mode, the operation of searching for phases of clock signals OCLK and OCLKX corresponding to adequate timing may be carried out using the clock signals P0, P45, P90, and P135, as has been described earlier with reference to FIG. 6. The operations of finding the phases of the clock signals OCLK and OCLKX at adequate timing may also be carried out using the clock signals M180, M225, M270, and M315.

Various registers are mounted in the phase adjustment sequencer 370 and implement the following functions while calibration mode is in effect:
(1) A register “PSEL<2:1>” holds the values of the phase selection signal PSEL<2:1> in the event n lanes (where n is an even number) are present and phase adjustments are made on a per lane basis. As n PSELs<2:1> are provided for n lanes, the values of PSEL<2:1> might vary from lane to lane.
(2) A register “sum2P” is used when summing up all lanes’ PSELs<2>. Its initial value is “0.”
(3) A register “sum1P” is used when summing up all lanes’ PSELs<1>. Its initial value is “0.”
(4) A register “ans2P” holds the answer or result of majority vote for PSEL<2>.
(5) A register “ans1P” holds the answer or result of majority vote for PSEL<1>.
(6) A register “numL2P” holds the number of lanes where the value of PSEL<2> matches ans2P.
(7) A register “numL1P” holds the number of lanes where the value of PSEL<1> matches ans1P.
(8) A register “Glb_PSEL<2:1>” holds the values of PSEL<2:1> to be set in all lanes. In other words, Glb_PSEL<2:1> holds the values of PSEL<2:1> at which the clock signals OCLK and OCLKX are generated with phases corresponding to adequate timing.
(9) A register “DCODE<m:1>” holds the values of the delay code DCODE when phase adjustments are made on a per lane basis. Its values are m bits and might vary from lane to lane.
(10) A register “sumD” is used when summing up the bit values of all lanes’ delay codes DCODEs<m:1>. sumD is initialized to “1” every time a sum of the bit values of a delay code DCODE<m:1> is calculated.
(11) A register “ansD<m:1>” holds the answer or result of majority vote for the delay code DCODE<m:1>.
(12) A register “numLD” holds the number of lanes where the values of the delay code DCODE<m:1> and ansD<m:1> match.
(13) A register “mnum” holds the number of bits there are between a bit in the delay code DCODE that is being processed and the least significant bit (LSB). In other words, mnum indicates the position of the bit being processed. mnum’s value is selected from among “1” to “m,” where “m” corresponds to the most significant bit (MSB).
(14) A register “Glb_DCODE<m:1>” holds the delay code DCODE to be set in all lanes. In other words, when the delay code DCODE<m:1> has values to match Glb_DCODE<m:1>, the clock signals OCLK and OCLKX are generated with phases corresponding to adequate timing.

Referring now to FIG. 7, after switching to calibration mode, in a step S102, the phase adjustment sequencer 370 resets a counter n to “1.” Next, in a step S104, the phase adjustment sequencer 370 picks a lane #n of the transmission channel 110 for processing. Next, in a step S106, the phase adjustment sequencer 370 outputs a phase selection signal PSEL, which causes the phase selector 380 to select the clock signal P0.

Next, in a step S108, the phase adjustment sequencer 370 switches the values of the delay code DCODE successively, causing the slicer 332 in the data receiving circuit 330A corresponding to lane #n to acquire a test data signal TDT. Next, in a step S110, the phase adjustment sequencer 370 determines whether the value of the test data signal TDT acquired in the slicer 332 has changed. For example, the phase adjustment sequencer 370 compares the test data signal TDT acquired at present, against the test data signal TDT that was acquired when the previous delay code DCODE was processed, and determines whether the test data signal TDT’s logical value has changed. If the value of the test data signal TDT has not changed, the phase adjustment sequencer 370 performs a step S112. If the value of the test data signal TDT has changed, the phase adjustment sequencer 370 performs a step S114. In step S112, the phase adjustment sequencer 370 increments the phase selection signal PSEL and then performs step S108.

The test data signal TDT has a pattern of “0101.” The range of phase change the clock signal OCLK undergoes when the loop from step S108 to step S112 is finished and the period the test data signal TDT’s logical value 1 or 0 lasts may be synchronized. Consequently, when the loop from step S108 to step S114 is repeated multiple times (hence “multiple loops”), in one loop, a change of the logical value of the test data signal TDT is detected.

In step S114, the phase adjustment sequencer 370 saves the values of the delay code DCODE and the values of the phase selection signal PSEL when a change of the value of the test data signal TDT is detected as mentioned above, as optimal phases for the lane #n presently being processed, in a register or a memory. Then, the phase adjustment sequencer 370 moves on to a step S116.

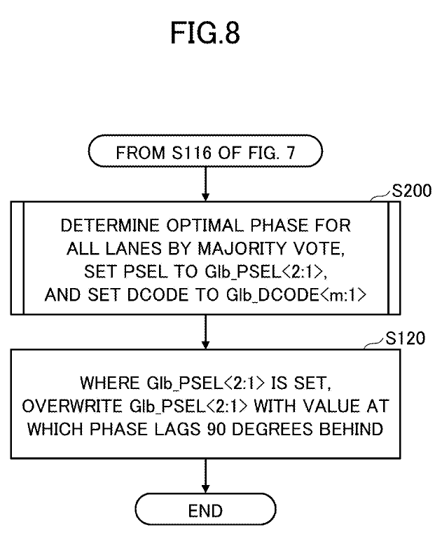

In step S116, the phase adjustment sequencer 370 determines whether the lane #n being processed is the last lane. If the lane #n being processed is the last lane, the phase adjustment sequencer 370 performs the step S200 of FIG. 8. By performing the steps shown in FIG. 7, the phase adjustment sequencer 370 can determine the phases of the clock signals OCLK and OCLKX such that the slicer 332 in the data receiving circuit 330A provided per lane #n becomes capable of acquiring the test data signal TDT properly before step S200 is performed. If the lane #n being processed is not the last lane yet, the phase adjustment sequencer 370 performs step S118. In step S118, the phase adjustment sequencer 370 increments “n” and returns to step S104.

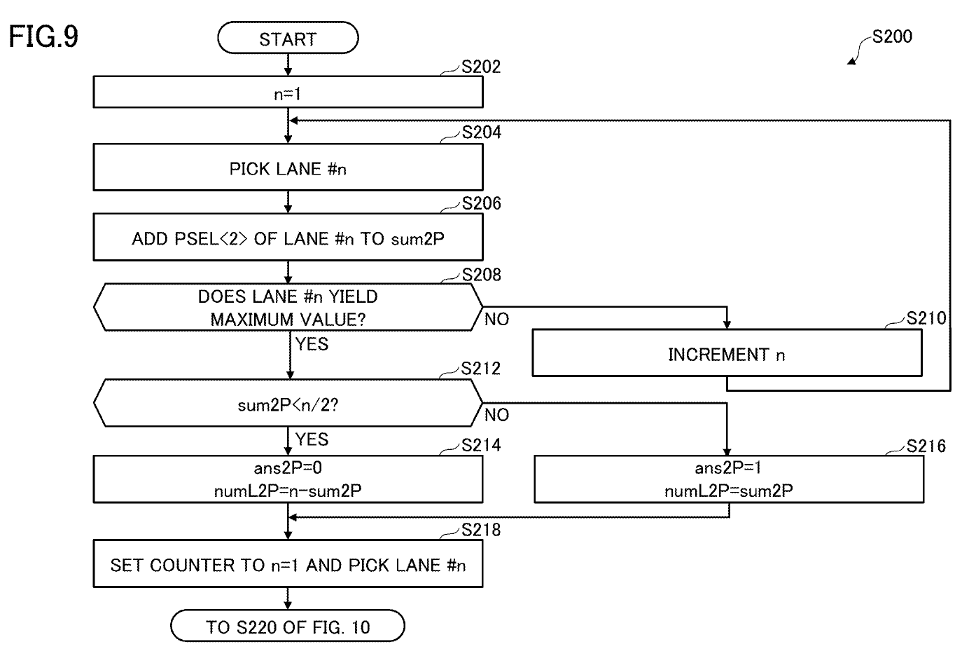

In step S200 of FIG. 8, the phase adjustment sequencer 370 takes a majority vote of all lanes’ optimal phases that were saved in step S114. The phase adjustment sequencer 370 sets the values of the phase selection signal PSEL and the values of the delay code DCODE, which correspond to the optimal phases determined by the majority vote, to Glb_PSEL<2:1> and Glb_DCODE<m:1>, respectively. Examples of step S200 will be described later with reference to FIG. 9 to FIG. 12.

Next, in step S120, the phase adjustment sequencer 370 rewrites Glb_PSEL<2:1>, which was set based on majority vote in step S20, with the values of PSEL<2:1> at which the clock signals OCLK and OCLKX that lag in phase by 90 degrees are generated, and thereupon finishes the operation shown in FIG. 7 and FIG. 8. As a result of this, in the operation of the system 100A after calibration mode is executed, the slicers 332 of all data receiving circuits 330A can use common clock signals OCLK and OCLKX having phases determined by majority vote and acquire data signals DT at adequate timing.

FIG. 9 to FIG. 12 show an example of the operation of step S200 in FIG. 8. First, in a step S202, the phase adjustment sequencer 370 resets the counter n to “1.” Next, in a step S204, the phase adjustment sequencer 370 picks a lane #n of the transmission channel 110. In a step S206, the phase adjustment sequencer 370 adds PSEL<2>, taken from PSEL<2:1> for lane #n saved in step S114 in FIG. 7, to sum2P. When PSEL<2> is “0,” it indicates that the clock signal P00 or P45 was selected for an optimal phase in the process of FIG. 7. When PSEL<2> is “1,” it indicates that the clock signal P90 or P135 was selected for an optimal phase in the process of FIG. 7.

Next, in a step S208, the phase adjustment sequencer 370 determines whether the lane #n that is presently being processed is the last lane. If the lane #n being processed is the last lane, the phase adjustment sequencer 370 performs a step S212. By the time step S212 is performed, the number of lanes where the clock signal P90 or P135 was selected for an optimal phase in the process of FIG. 7 is saved as sum2P. If the lane #n being processed is not the last lane yet, the phase adjustment sequencer 370 performs a step S210. In step S210, the phase adjustment sequencer 370 increments “n” and returns to step S204.

In step S212, the phase adjustment sequencer 370 compares sum2P with n/2, which is 1/2 of the number of lanes. sum2P being less than 1/2 of the number of lanes n indicates that the clock signal P0 or P45 is selected for an optimal phase in the majority of lanes #n, so the phase adjustment sequencer 370 performs a step S214. sum2P being greater than or equal to 1/2 of the number of lanes n indicates that the clock signal P90 or P135 is selected for an optimal phase in the majority of lanes #n, so the phase adjustment sequencer 370 performs a step S216.

In step S214, the phase adjustment sequencer 370 sets ans2P, which is the answer or result of majority vote for PSEL<2>, to “0.” This “0” indicates that the clock signal P0 or P45 provides an optimal phase. The phase adjustment sequencer 370 also sets the difference between the number of lanes n and sum2P to numL2P, where numL2P is the number of lanes where the answer or result of majority vote for PSEL<2> was “0,” and then performs a step S218.

In step S216, the phase adjustment sequencer 370 sets ans2P, which is the answer or result of majority vote for PSEL<2>, to “1.” This “1” indicates that the clock signal P90 or P135 provides an optimal phase. The phase adjustment sequencer 370 also sets sum2P to numL2P, where numL2P is the number of lanes where the answer or result of majority vote for PSEL<2> was “1,” and performs a step S218. In step S218, the phase adjustment sequencer 370 resets the counter n to “1” and picks the next lane #n.

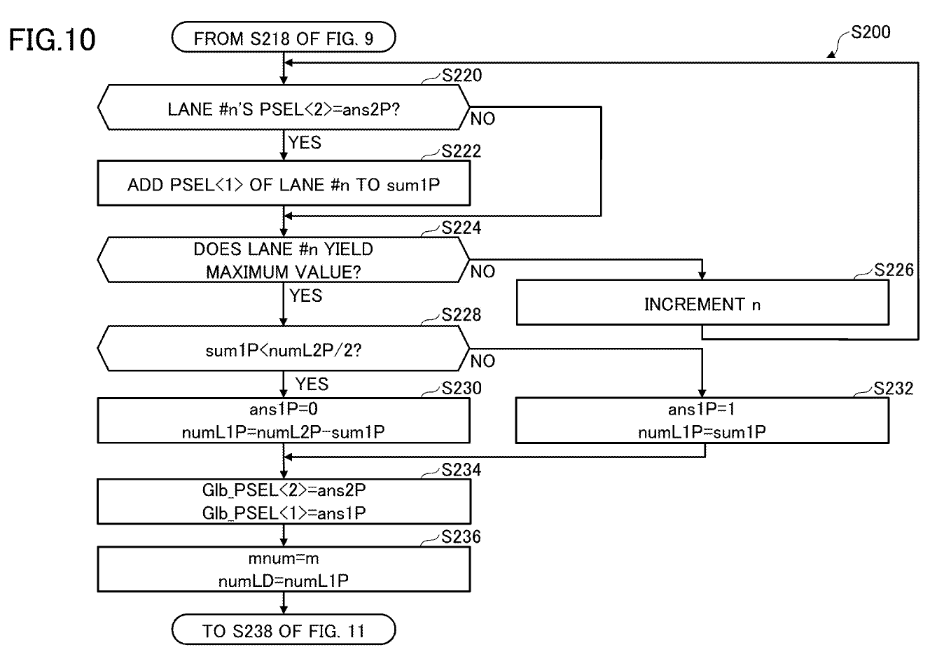

Next, in a step S220 of FIG. 10, the phase adjustment sequencer 370 compares PSEL<2> of lane #n with ans2P, which is the answer or result of the majority vote taken in step S214 or step S216. If PSEL<2> and ans2P are equal, this indicates that the lane selected at present was elected by majority vote for PSEL<1>, so the phase adjustment sequencer 370 performs a step S222. If PSEL<2> and ans2P are not equal, this indicates that the lane selected at present was not elected by majority vote for PSEL<1>, so the phase adjustment sequencer 370 performs a step S224 without performing step S222.

In other words, when taking a majority vote on the lower-order bit side in the phase selection signal PSEL, the phase adjustment sequencer 370 sums up the logical 1s and logical 0s that make up the phase selection signal PSEL, by excluding the values of the phase selection signal PSEL not including the logical value 1 or 0 elected as the answer or result of a majority vote taken on the higher-order bit side in the phase selection signal PSEL. By this means, in the process of searching for adequate phases of the clock signals OCLK and OCLKX, it is possible to prevent or substantially prevent unnecessary additions or the like from being calculated, thereby preventing or substantially preventing the search from taking a long time.

In step S222, where PSEL<1> is the low-order bit in PSEL<2:1> for lane #n that was subject to majority vote, the phase adjustment sequencer 370 adds the value of PSEL<1> to sum1P and performs step S224.

In step S224, the phase adjustment sequencer 370 determines whether the lane #n that is presently being processed is the last lane. If the lane #n being processed is the last lane, the phase adjustment sequencer 370 performs a step S228. If the lane #n being processed is not the last lane yet, the phase adjustment sequencer 370 performs a step S226. In step S226, the phase adjustment sequencer 370 increments “n” and returns to step S220.

In step S228, the phase adjustment sequencer 370 compares sum1P with numL2P/2. numL2P is the number of lanes matching the answer or result of majority vote for PSEL<2>. sum1P being less than 1/2 of numL2P indicates that the lanes #n where the clock signal P0 or P90 was elected for an optimal phase accounts for the majority of numL2P, so the phase adjustment sequencer 370 performs a step S230. sum1P being greater than or equal to 1/2 of numL2P indicates that the number of lanes #n where the clock signal P45 or P135 was elected for an optimal phase is greater than or equal to numL2P, so the phase adjustment sequencer 370 performs a step S232.

In step S230, the phase adjustment sequencer 370 sets ans1P, which is the answer or result of majority vote for PSEL<1>, to “0.” This “0” indicates that the clock signal P0 or P90 provides an optimal phase. Provided that numL1P is the number of lanes where the answer or result of majority vote for PSEL<2:1> was “0” and numL2P is the number of lanes where the answer or result of majority vote for PSEL<2> was “0,” the phase adjustment sequencer 370 sets the difference between numL2P and sum1P to numL1P and performs a step S234. The difference between numL2P and sum1P is the number of lanes where PSEL<1> is “0” among the lanes #n subject to majority vote.

In step S232, the phase adjustment sequencer 370 sets ans1P, which is the answer or result of majority vote for PSEL<1>, to “1.” This “1” indicates that the clock signal P45 or P135 provides an optimal phase. The phase adjustment sequencer 370 also sets sum1P to numL1P, where numL1P is the number of lanes where the answer or result of majority vote for PSEL<2:1> was “1,” and performs step S234. sum1P is the number of lanes where PSEL<1> is “1” among the lanes #n subject to majority vote.

In step S234, the phase adjustment sequencer 370 sets Glb_PSEL<2>, which is the value of PSEL<2> to be set in all lanes #n, to ans2P, which was determined in step S214 or step S216 of FIG. 9. The phase adjustment sequencer 370 also sets Glb_PSEL<1>, which is the value of PSEL<1> to be set in all lanes #n, to ans1P, which was determined in step S230 or step S232. By this means, for example, in the event the clock signals P0, P45, P90, and P135 are present, the phase of a clock signal at which the test data signal TDT’s logical value changes more often than with other clock signals can be elected by majority vote, in all lanes #n.

Next, in step S236, the phase adjustment sequencer 370 sets the processing-target bit position “mnum” in the processing-target delay code DCODE to “m.” “m” stands for the most significant bit. Also, where “numLD” is the number of lanes where the value of the delay code DCODE<m:1> matches ansD<m:1>, which is the answer or result of majority vote, the phase adjustment sequencer 370 sets numLD to numL1P. In the process from step S236 onwards, appropriate values for the delay code DCODE are determined by majority vote.

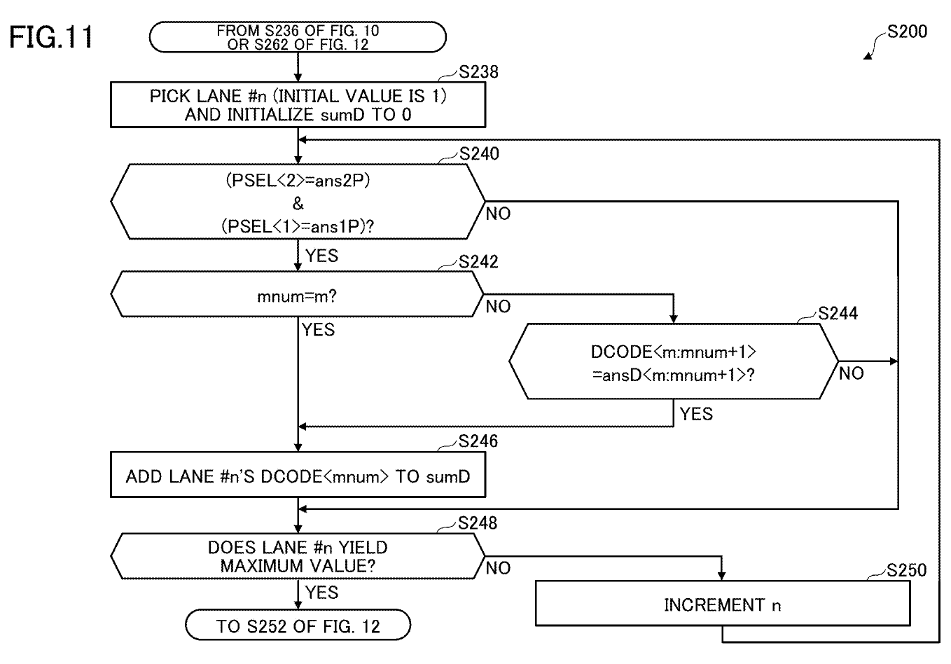

Next, in step S238 of FIG. 11, the phase adjustment sequencer 370 sets the initial value on the counter n to “1” and picks the next lane #n, and initializes sumD, which is a variable for use when summing up the bit values of the delay code DCODE, to “0.”

Next, in a step S240, the phase adjustment sequencer 370 compares PSEL<2> with ans2P and compares PSEL<1> with ans1P. If PSEL<2> and ans2P are equal and PSEL<1> and ans1P are equal, the lane #n that is presently being processed is subject to phase search, so the phase adjustment sequencer 370 performs a step S242. If PSEL<2> and ans2P are not equal or PSEL<1> and ans1P are not equal, the lane #n that is presently being processed is not subject to phase search, so the phase adjustment sequencer 370 performs a step S248 without executing steps S242, S244, and S246. By this means, in the process of searching for optimal phases for the clock signals OCLK and OCLKX, it is possible to prevent or substantially prevent unnecessary additions or the like from being calculated, thereby preventing or substantially preventing the search from taking a long time. As a result of this, furthermore, the time the phase adjustment sequence 370 operates in calibration mode can be shortened, allowing for a decrease in power consumption.

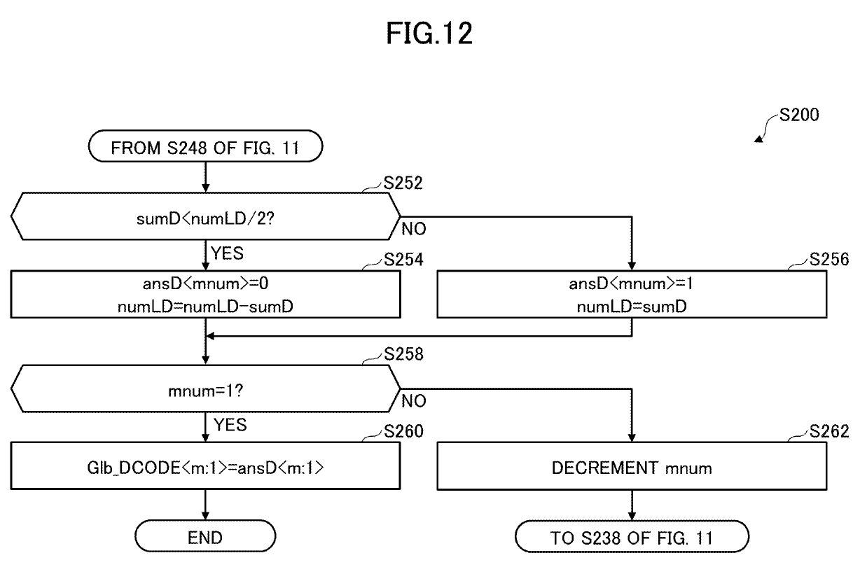

In step S242, the phase adjustment sequencer 370 determines whether the bit position mnum being processed in the delay code DCODE is the most significant bit m. If the bit is the most significant bit m, the phase adjustment sequencer 370 performs step S246. If the bit is not the most significant bit m, the phase adjustment sequencer 370 performs step S244. In other words, in the loop repeated as shown in FIG. 11 and FIG. 12 for each lane #n, for the first time/loop in which the bit position mnum is the most significant bit m, step S244 is not carried out; from the second time/loop onwards, the bit position mnum is no longer the most significant bit m, so step S244 is carried out.

In step S244, the phase adjustment sequencer 370 compares the delay code DCODE<m: mnum+1> with ansD<m: mnum+1>. ansD<m: mnum+1> is the answer or result of majority vote for the delay code DCODE<m: mnum+1> determined thus far. If the ongoing loop is the second time around or a later loop and the bit position mnum is therefore no longer that of the most significant bit m, it follows that the process from step S246 onwards has been performed on the high-order bit up until then and ansD<m: mnum+1> therefore already has a value. If DCODE<m: mnum+1> and ansD<m: mnum+1> are equal, the phase adjustment sequencer 370 performs step S246 to take a majority vote including mnum. If DCODE<m: mnum+1> and ansD<m: mnum+1> are not equal, the phase adjustment sequencer 370 performs step S248, to exclude mnum when taking a majority vote. As a result of this, it is possible to prevent or substantially prevent unnecessary additions or the like from being calculated, thereby preventing or substantially preventing the search from taking a long time.

In step S246, the phase adjustment sequencer 370 adds DCODE<mnum> of lane #n to sumD. Next, in step S248, the phase adjustment sequencer 370 determines whether the lane #n being processed is the last lane. If the lane #n being processed is the last lane, the phase adjustment sequencer 370 performs a step S252 as shown in FIG. 12. If the lane #n being processed is not the last lane yet, the phase adjustment sequencer 370 performs a step S250. In step S250, the phase adjustment sequencer 370 increments “n” and returns to step S240.

In step S252 of FIG. 12, the phase adjustment sequencer 370 compares sumD with numLD/2. numLD is the number of lanes matching the answer or result of the majority vote for the delay code DCODE match. sumD being less than 1/2 of numLD indicates that the delay code DCODE<mnum> is “0” in the majority of lanes #n where a majority vote was taken, so the phase adjustment sequencer 370 performs a step S254. sumD being greater than or equal to 1/2 of numLD indicates that the delay code DCODE<mnum> is “1” in the majority of lanes #n where a majority vote was taken, so the phase adjustment sequencer 370 performs a step S256.

In step S254, the phase adjustment sequencer 370 sets ansD<mnum>, which is the answer or result of the majority vote for the bit position mnum being processed, to “0.” numLD is the number of lanes matching the answer or result of the majority vote for the delay code DCODE<m:1>. The phase adjustment sequencer 370 subtracts sumD from numLD, updates numLD, and performs a step S258. In step S256, the phase adjustment sequencer 370 sets ansD<mnum> to “1,” sets numLD to sumD, and performs step S258.

In step S258, the phase adjustment sequencer 370 determines whether mnum is “1.” That is, the phase adjustment sequencer 370 determines whether a majority vote has been taken up to the least significant bit of the delay code DCODE. If mnum is “1,” this indicates that appropriate values have been found for the delay code DCODE, so the phase adjustment sequencer 370 performs a step S260. If mnum is not “1,” this indicates that there are still bits in the delay code DCODE where a majority vote has not been taken, so the phase adjustment sequencer 370 performs a step S262.

In step S260, the phase adjustment sequencer 370 sets Glb_DCODE<m:1>, which is the value of the delay code DCODE<m:1> to be set in all lanes #n, to ansD<m:1>, and thereupon finishes the operation of step S200 shown in FIG. 9 to FIG. 12. In step S262, the phase adjustment sequencer 370 decrements mnum, thus shifting the bit mnum subject to majority vote in the delay code DCODE by one bit toward the least significant bit, and returns to step S238 of FIG. 11.

As described above, according to this embodiment, the clock signals OCLK and OCLKX, which allow multiple data receiving circuits 330A to acquire data, have their phases set by the variable delay circuit 350 and phase selector 380 that are provided in common for and outside the data receiving circuits 330A. This can reduce the power consumption of the receiving circuit 310A compared to when a phase shift circuit and other circuits for setting the phases of the clock signals OCLK and OCLKX are provided in each data receiving circuit 330A.

The phase adjustment sequencer 370 determines, for each data receiving circuit 330A, the phases of the clock signals OCLK and OCLKX such that data signals can be received properly in each data receiving circuit 330A. Then, by taking a majority vote of phases determined thus, the phase adjustment sequencer 370 sets common clock signals OCLK and OCLKX corresponding to adequate timing in all data receiving circuits 330A. By this means, even when a common variable delay circuit 350 and phase selector 380 for setting the phases of the clock signals OCLK and OCLKX are provided for multiple data receiving circuits 330A, it is still possible to generate clock signals that enable the data receiving circuits 330A to receive data signals at adequate timing.

The phase adjustment sequencer 370 controls the variable delay circuit 350 and phase selector 380 to shift the phases of the clock signals OCLK and OCLKX successively, so that it is possible to generate, for each data receiving circuit 330A, the clock signals OCLK and OCLKX of adequate timing for receiving data signals.

The phase adjustment sequencer 370 sets the values of the delay code DCODE and the phase selection signal PSEL, which correspond to the clock signals OCLK and OCLKX of adequate timing determined during calibration mode, in the variable delay circuit 350 and the phase selector 380, respectively. As a result of this, after calibration mode switches to system operation mode, each data receiving circuit 330A can receive data signals at adequate timing.

Provided that this process of summing up the logical 1s and logical 0s that make up the phase selection signal PSEL, in order from a high-order bit, and determining either the logical value 1 or 0 that accounts for the majority in a majority vote as the answer or result of the majority vote is repeated, when the phase adjustment sequencer 370 takes a majority vote on the lower-order bit side, the phase adjustment sequencer 370 sums up the logical 1s and logical 0s that make up the phase selection signal PSEL, by excluding the values of the phase selection signal PSEL that do not include the logical value 1 or 0 elected as the answer or result of the majority vote on the higher-order bit side. This prevents or substantially prevents unnecessary additions or the like from being calculated in the process of searching for adequate phases of the clock signals OCLK and OCLKX, thereby preventing or substantially preventing the search from taking a long time.

Provided that the process of summing up the logical 1s and logical 0s that make up the delay code DCODE, in order from a high-order bit, and electing either the logical value 1 or 0 that accounts for the majority in a majority vote as the answer or result of the majority vote is repeated, when the phase adjustment sequencer 370 takes a majority vote on the lower-order bit side, the phase adjustment sequencer 370 likewise sums up the logical 1s and logical 0s that make up the delay code DCODE, but by excluding the values of the delay code DCODE that do not include the logical value 1 or 0 elected as the answer or result of the majority vote on the higher-order bit side of the delay code DCODE. Furthermore, the phase adjustment SEQUENCER 370 sums up the logical 1s and logical 0s that make up the delay code DCODE, by excluding the values of the delay code DCODE corresponding to the values of the phase selection signal PSEL that do not include the logical value 1 or 0 elected earlier as the answer or result of the majority vote for the phase selection signal PSEL. By this means, in the process of searching for adequate phases of the clock signals OCLK and OCLKX, it is possible to prevent or substantially prevent unnecessary additions or the like from being calculated, thereby preventing or substantially preventing the search from taking a long time. As a result of this, furthermore, the time the phase adjustment sequence 370 operates in calibration mode can be shortened, allowing for a decrease in power consumption.

The present invention has been described above based on an embodiment, but the present invention is by no means limited to the specifics and requirements set forth in the above embodiment. These features of the present invention may be changed without departing from the spirit of the present invention and may be determined as appropriate depending on the mode of application.

What is claimed is:

1. A receiving circuit comprising:
a clock generating circuit configured to generate a reception clock signal; and
a plurality of data receiving circuits configured to receive respective data signals based on the reception clock signal,
wherein the clock generating circuit includes:
a clock receiving circuit configured to receive a reference clock signal;
a variable delay circuit configured to generate a delayed reference clock signal by delaying the reference clock signal received by the clock receiving circuit by a delay amount responsive to a delay control signal;
a delay synchronization circuit configured to generate a plurality of internal clock signals by delaying the delayed reference clock signal successively; and
a selector circuit configured to select one of the plurality of internal clock signals based on a phase selection signal and output the selected internal clock signal as the reception clock signal.

2. The receiving circuit according to claim 1, wherein the reception clock signal is a same clock signal shared by the plurality of data receiving circuits.

3. The receiving circuit according to claim 1, further comprising a phase adjustment control circuit configured to generate the delay control signal and the phase selection signal.

4. The receiving circuit according to claim 3, wherein the phase adjustment control circuit is further configured to control the variable delay circuit and the selector circuit to:
determine, for each of the plurality of receiving circuits, a phase of the reception clock signal enabling a corresponding one of the data signals to be received at valid timing, by sequentially shifting the phase of the reception clock signal, thereby determining phases of the reception clock signal for respective ones of the data receiving circuits; and
determine a common phase of the reception clock signal that applies to the plurality of data receiving circuits by taking a majority vote of the determined phases of the reception clock signal.

5. The receiving circuit according to claim 3,
wherein each of a value of the phase selection signal and a value of the delay control signal is represented by a plurality of bits, and
wherein the phase adjustment control circuit is further configured to determine, for each of the plurality of data receiving circuits, a phase of the reception clock signal enabling a corresponding one of the data signals to be received at valid timing, by sequentially changing the value of the delay control signal for each value of the phase selection signal.

6. The receiving circuit according to claim 4, wherein the phase adjustment control circuit is configured to count, for each bit position selected in a descending order in the phase selection signal, a total number of logical values of 1 or a total number of logical values of 0 across respective phase selection signals of the data receiving circuits to determine a logical value that accounts for a majority in the selected bit position, thereby determining a result of a majority vote of the phase selection signals in the taking of the majority vote of the determined phases.

7. The receiving circuit according to claim 6, wherein the phase adjustment control circuit is configured to determine the logical value that accounts for the majority in a first bit position lower than a second bit position by counting the total number of logical values of 1 or the total number of logical values of 0 for the first bit position across a subset of the phase selection signals, the subset excluding phase selection signals that do not have the logical value accounting for the majority in the second bit position, thereby determining the result of the majority vote of the phase selection signals in the taking of the majority vote of the determined phases.

8. The receiving circuit according to claim 6, wherein with respect to a phase indicated by the result of the majority vote of the phase detection signals, the phase adjustment control circuit is configured to count, for each bit position selected in a descending order in the delay control signal, a total number of logical values of 1 or a total number of logical values of 0 across respective delay control signals of the data receiving circuits to determine a logical value that accounts for a majority in the selected bit position, thereby determining a result of a majority vote of the delay control signals.

9. The receiving circuit according to claim 8, wherein with respect to the phase indicated by the result of the majority vote of the phase detection signals, the phase adjustment control circuit is configured to determine the logical value that accounts for the majority in a first bit position lower than a second bit position by counting the total number of logical values of 1 or the total number of logical values of 0 for the first bit position across a subset of the delay control signals, the subset excluding delay control signals that do not have the logical value accounting for the majority in the second bit position, thereby determining the result of the majority vote of the delay control signals.

10. The receiving circuit according to claim 3, wherein the phase adjustment control circuit is further configured to:
determine a value of the phase selection signal and a value of the delay control signal such that the reception clock signal is generated with a phase determined by majority vote;
output the determined value of the phase selection signal to the selector circuit; and
output the determined value of the delay control signal to the variable delay circuit.

11. The receiving circuit according to claim 3, wherein the phase adjustment control circuit is further configured to operate in a test mode to generate the delay control signal and the phase selection signal.

12. The receiving circuit according to claim 11,
wherein the phase adjustment control circuit is further configured to control the variable delay circuit and the selector circuit such that, when the test mode is in effect, a phase of the reception clock signal is set as a phase determined by majority vote, and
wherein the plurality of data receiving circuits are further configured to receive the respective data signals, when a system operation mode is in effect after the test mode, based on the reception clock signal having the phase set by the phase adjustment control circuit.

13. The receiving circuit according to claim 1,
wherein each of the reference clock signal, the delayed reference clock signal, the internal clock signals, and the reception clock signal is a differential clock signal, and
wherein the delay synchronization circuit is a differential delay synchronization circuit configured to operate with a differential signal as an input.

14. The receiving circuit according to claim 1, wherein the delay synchronization circuit includes:
a delay buffer sequence including a plurality of delay buffers connected in series, a first stage of the delay buffer in the delay buffer sequence receiving the delay reference clock signal and the delay buffer sequence generating the plurality of internal clock signals having respective phases which are different from each other; and
a delay adjustment circuit configured to adjust a delay in the plurality of delay buffers based on a phase difference between the internal clock signals output from two of the plurality of delay buffers.

15. The receiving circuit according to claim 1, wherein the variable delay circuit includes:
a voltage generating circuit configured to generate a voltage responsive toa value of the delay control signal; and
a delay buffer configured to generate the delayed reference clock signal by delaying the reference clock signal according to the voltage, a delay amount of the delay buffer being varied according to the voltage.

16. The receiving circuit according to claim 1, wherein each of the plurality of data receiving circuits includes a serial-to-parallel conversion circuit configured to convert a plurality of serial data signals into parallel data signals, the plurality of serial data signals being received successively via a transmission channel.

17. The receiving circuit according to claim 1, wherein the respective data signals that the plurality of data receiving circuits receive are a plurality of data signals which are independent of each other.

18. A semiconductor integrated circuit comprising:
a receiving circuit including:
a clock generating circuit configured to generate a reception clock signal; and
a plurality of data receiving circuits configured to receive respective data signals based on the reception clock signal; and
a processing circuit configured to process the respective data signals received by the receiving circuit,
wherein the clock generating circuit includes:
a clock receiving circuit configured to receive a reference clock signal;
a variable delay circuit configured to generate a delayed reference clock signal by delaying the reference clock signal received by the clock receiving circuit by a delay amount responsive to a delay control signal;
a delay synchronization circuit configured to generate a plurality of internal clock signals by delaying the delayed reference clock signal successively; and
a selector circuit configured to select one of the plurality of internal clock signals based on a phase selection signal and output the selected internal clock signal as the reception clock signal.

19. A communication system comprising:
a transmitting circuit including:
a first clock generating circuit configured to generate a reference clock signal; and
a plurality of data transmitting circuits configured to transmit respective data signals based on the reference clock signal; and
a receiving circuit including:
a second clock generating circuit configured to generate a reception clock signal based on the reference clock signal; and
a plurality of data receiving circuits provided in association with the plurality of data transmitting circuits and configured to receive the respective data signals based on the reception clock signal,
wherein each of the plurality of data transmitting circuits includes:
a data generating circuit configured to generate a test data signal; and
a selection circuit configured to select either the test data signal or a data signal and output the selected signal as a corresponding one of the respective data signals, and
wherein the second clock generating circuit includes:
a clock receiving circuit configured to receive the reference clock signal;
a variable delay circuit configured to generate a delayed reference clock signal by delaying the reference clock signal received by the clock receiving circuit by a delay amount responsive to a delay control signal;
a delay synchronization circuit configured to generate a plurality of internal clock signals by delaying the delayed reference clock signal successively; and
a selector circuit configured to select one of the plurality of internal clock signals based on a phase selection signal and output the selected internal clock signal as the reception clock signal.

20. The communication system according to claim 19, wherein the selection circuit is configured to select the test data signal when a test mode is in effect and select the data signal when a system operation mode is in effect after the test mode.
